(19) United States
(12) Patent Application Publication
(10) Pub. No.: US 2014/0277921 A1
(43) Pub. Date: Sep. 18, 2014

(54) SYSTEM AND METHOD FOR DATA ENTITY IDENTIFICATION AND ANALYSIS OF MAINTENANCE DATA

(71) Applicant: GENERAL ELECTRIC COMPANY, Schenectady, NY (US)

(72) Inventors: Vineel Chandrakanth Gujjar, Bangalore (IN); Debasis Bal, Bangalore (IN); Gopi Subramanian, Bangalore (IN); Brian David Larder, Southampton (GB); Andrew James Smith, Southampton (GB); Mark Thomas Harrington, Cheltenham (GB)

(73) Assignee: GENERAL ELECTRIC COMPANY, Schenectady, NY (US)

(21) Appl. No.: 13/829,619

(22) Filed: Mar. 14, 2013

(51) Int. Cl. B64F 5/00

(52) U.S. Cl. CPC B64F 5/0045
USPC 701/32.9

(57) ABSTRACT

A method for identifying and analyzing data entities from (maintenance, repair, and overhaul (MRO)) data is provided. The method includes obtaining MRO data comprising unstructured text information. The method also includes performing named entity recognition on the MRO data to extract entities from the unstructured text information and label the entities with a tag. The method further includes analyzing the labeled entities via a heuristic to estimate an effectiveness of a fix for a specific issue or to estimate a reliability of a component.

### BACKGROUND

The subject matter disclosed herein relates to data entity identification and analysis, such as data entity identification and analysis of maintenance data.

In certain industries, vehicles or industrial machinery require regular maintenance and in some cases repair and/or overhaul due to their constant usage. For example, aviation services include aircraft maintenance data, known as maintenance, repair, and overhaul (MRO) data in maintenance logs or records. Typically, the MRO data includes information on problems (e.g., symptoms) in the aircraft and corresponding repair actions (e.g., fixes or corrective actions). Due to the complex nature of aircraft, many times an engineer may try several fixes for a particular problem. However, due to the amount of historical MRO data and/or accessibility of the data, it may be difficult to determine the effectiveness of a fix for a particular problem and/or the reliability of a particular part or component.

### BRIEF DESCRIPTION

In accordance with a first embodiment, a method for identifying and analyzing data entities from (maintenance, repair, and overhaul (MRO)) data is provided. The method includes obtaining MRO data comprising unstructured text information. The method also includes performing named entity recognition on the MRO data to extract entities from the unstructured text information and label the entities with a tag. The method further includes analyzing the labeled entities via a heuristic to estimate an effectiveness of a fix for a specific issue or to estimate a reliability of a component.

In accordance with a second embodiment, a system for identifying and analyzing data entities from (maintenance, repair, and overhaul (MRO)) data is provided. The system includes a memory structure encoding one or more processor-executable routines, when executed, cause acts to be performed. The acts include performing named entity recognition on MRO data to extract entities and to label the entities with a tag, wherein the MRO data comprises unstructured text information, and the tag indicates if a particular entity is a part, an issue, or a corrective-action. The acts also include analyzing the labeled entities via a heuristic to estimate an effectiveness of a fix for a specific issue or to estimate a reliability of a component. The system also includes a processing component configured to access and execute the one or more routines encoded by the memory structure.

In accordance with a third embodiment, one or more non-transitory computer-readable media encoding one or more processor-executable routines is provided. The one or more routines, when executed by a processor, cause acts to be performed. The acts include performing named entity recognition on (maintenance, repair, and overhaul (MRO)) data to extract entities and to label the entities with a tag, wherein the MRO data comprises unstructured text information, and the tag indicates if the entity is a part, an issue, or a corrective-action. The acts also include analyzing the labeled data entities via a heuristic to estimate an effectiveness of a fix for a specific issue or to estimate a reliability of a component.

### BRIEF DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 is a diagrammatical overview of an embodiment of a data entity identification and analysis system;

FIG. 2 is a process flow diagram of an embodiment of a method for identifying and analyzing data entities using the system illustrated in FIG. 1;

FIG. 3 is a process flow diagram of an embodiment of a method for building a spell correction model and for correcting the spelling of text data;

FIG. 4 is a process flow diagram of an embodiment of a method for building a synonym identification model and for normalizing synonyms of text data;

FIG. 5 is a process flow diagram of an embodiment of a method for building a named entity recognition model and for extracting entities from text data;

FIG. 6 is a process flow diagram of an embodiment of a method for analyzing extracted entities (e.g., fix effectiveness);

FIG. 7 is a graphical representation of an embodiment of an effectiveness chart;

FIG. 8 is a process flow diagram of an embodiment of a method for analyzing extracted entities (e.g., reliability of component);

FIG. 9 is a graphical representation of an embodiment of a component reliability chart;

FIG. 10 is a process flow diagram of an embodiment of a method for analyzing extracted entities (e.g., symptom cluster analysis);

FIG. 11 is a graphical representation of an embodiment of symptom clusters;

FIG. 12 is a process flow diagram of an embodiment of a method for using a user interface to view fix effectiveness;

FIG. 13 is a representation of an embodiment of a user interface to view fix effectiveness (e.g., parts selected);

FIG. 14 is a representation of an embodiment of a user interface to view fix effectiveness (e.g., issues selected);

FIG. 15 is a representation an embodiment of the user interface of FIG. 13 upon selecting a specific part;

FIG. 16 is a representation of an embodiment of the user interface of FIG. 14 upon selecting a specific issue; and

FIG. 17 is a representation of an embodiment of a user interface displaying fix effectiveness information.

### DETAILED DESCRIPTION

While the following discussion is generally provided in the context of aircraft maintenance data (specifically, MRO data), it should be appreciated that the present techniques are not limited to use in the context of aircraft. Indeed, the provision of examples and explanations in the context of aircraft MRO data is only to facilitate explanation by providing instances of real-world implementations and applications. However, the present approaches may also be utilized in other contexts, such as the maintenance logs or records of industrial machinery (e.g., heavy equipment, agricultural equipment, petroleum refinery equipment, etc.), of any type of transportation vehicle, or of any other type of equipment.

Turning to the drawings and referring first to FIG. 1, a data entity identification and analysis system 10 is illustrated diagrammatically for identifying and analyzing data entities within MRO data. A “data entity” is a data object that has a data type (e.g., part, issue, corrective-action, etc.). In the embodiment illustrated in FIG. 1, the system 10 includes a processing system 12 which utilizes various algorithms, models, and heuristics 16 (e.g., text mining algorithms/models, analysis models, etc.) for identifying and analyzing data entities from any of a range of data sources 18 (e.g., unstructured data or text 20 from aircraft maintenance logs or records). For example, as described in greater detail below, the processing system 12 may develop and utilize algorithms, models, and/or heuristics 16 for correcting spelling errors within the unstructured text of the MRO data and/or normalizing synonyms within the unstructured text or spell-corrected, unstructured text. In addition, the processing system 12 may develop and utilize models/algorithms/heuristics 16 (e.g., hidden Markov model (HMM)) for deriving a fixed effectiveness (e.g., for specific symptoms and corresponding fixes or corrective-actions) or a reliability for particular parts or components. The processing system 12 will generally include one or more programmed computers (and associated processors and memories), which may be located at one or more locations. The algorithms/models/heuristics 16 themselves may be stored in the processing system 12, or may be accessed by the processing system 12 when called upon to identify or analyze the data entities. To permit user interface with the algorithms/models/heuristics 16, the data sources 18, and data entities themselves, a series of editable interfaces 22 are provided. Again, such interfaces 22 may be stored in the processing system 12 or may be accessed by the system 12 as needed. The interfaces 22 generate a series of views 24 about which more will be said below. In general, the views allow for developing the models 16, analysis of data entities, viewing and interaction with the analytical results, and viewing and interaction with data entities themselves.

Furthermore, by way of example only, the present techniques may be applied to identification of data entities within textual documents (e.g., aircraft maintenance logs or records), as well as documents with other forms and types of data, such as image data, audio data, waveform data, and so forth, as discussed below. As will be discussed in greater detail below, however, while the present techniques provide unprecedented tools for analysis of textual documents, the invention is not limited to application with textual data only. The techniques may be employed with data entities such as images, audio data, waveform data, and data entities which include or are associated with one another having one or more of these types of data (i.e., text and images, text and audio, images and audio, text and images and audio, etc.).

Utilizing the algorithms/models/heuristics 16, the processing system 12 accesses the data sources 18 to identify and analyze individual data entities. For example, the present technique may be used to identify and analyze the unstructured MRO data 20. Unstructured MRO data entities may not include any such identifiable fields, but may be, instead, “raw” or unprocessed data (e.g., handwritten or free form notes or comments) for which more or different processing may be in order (e.g., spelling correction and/or synonym normalization). Moreover, such unstructured MRO data from the maintenance logs or records may be located within databases 26.

The present techniques provide several useful functions that should be considered as distinct, although related. First, “identification” of data entities relates to the selection and extraction of entities of interest, or of potential interest from the unstructured MRO data 20 and labeling or tagging the entities (e.g., to identify the entity as a part, issue, or corrective-action) utilizing the algorithms/models/heuristics 16. “Analysis” of the entities entails examination of the features defined by the data and/or the relationships between the data. Many types of analysis may be performed, based upon the labels or tags, and the algorithms/models/heuristics 16, for example, to identify relationships or patterns in the data.

As mentioned above, the processing system 12 also draws upon rules and algorithms/models/heuristics 16 for identifying and analyzing the data entities. As discussed in greater detail below, the algorithms/models/heuristics 16 will typically be adapted for specific purposes (e.g., identification and analysis) of the data entities. For example, the algorithms/models/heuristics 16 may pertain to analysis and/or correction of text in textual documents. The algorithms/models/heuristics 16 may be stored in the processing system 12, or may be accessed as needed by the processing system 12. Sophisticated algorithms for the analysis (e.g., clustering algorithm) and identification of features of interest (e.g., text mining algorithms) in the textual documents may be among the algorithms, and these may be drawn upon as needed for identification and analysis of the data entities.

The data processing system 12 is also coupled to one or more storage devices 28 for storing results of searches, results of analyses, user preferences, and any other permanent or temporary data that may be required for carrying out the purposes of the identification and analysis. In particular, storage 28 may be used for storing the databases 26 and algorithms/models/heuristics 16.

A range of editable interfaces 22 may be envisaged for interacting with the development of the models and algorithms 16, and the analysis of the entities themselves. By way of example only, as illustrated in FIG. 1, such interfaces 22 are presently contemplated. These may include an interface 30 provided for developing and/or verifying algorithms or models 16. Result viewing interfaces 32 are contemplated for illustrating the results of analysis of one or more data entities. The interfaces 22 will typically be served to the user by a workstation 34 (e.g., via display 36) which is linked to the processing system 12. Indeed, the processing system 12 may be part of a workstation 34, or may be completely remote from the workstation 34 and linked by a suitable network. Many different views 24 may be served as part of the interfaces 22, including views enumerated in FIG. 1, and designated a stamp view, a form view, a table view, a highlight view, a basic spatial display (splay), a splay with overlay, a user-defined schema, or any other view. It should be borne in mind that these are merely exemplary reviews of analysis, and many other views or variants of these views may be envisaged.

Keeping in mind the operation of the system 10 above with respect to FIG. 1, FIG. 2 illustrates a process flow diagram of an embodiment of a method 38 for identifying and analyzing data entities from unstructured MRO data 20. Any suitable application-specific or general-purpose computer having a memory and processor may perform some or all of the steps of the method 38 and other methods described below. By way of example, as noted above with respect to FIG. 1, the processing system 12 and storage 28 or workstation 34 may be configured to perform the method 38. For example, the storage 28 or memory of the workstation 34, which may be any tangible, non-transitory, machine-readable medium (e.g., an optical disc, solid state device, chip, firmware), may store one or more sets of instructions that are executable by a processor of the processing system 12 or of the workstation 34 to perform the steps of method 38 and the other methods described below.

Turning to FIG. 2, in the depicted implementation, the method 38 includes obtaining (e.g., receiving data from the storage 28) raw data 40 (e.g., MRO data) (block 42). The raw data 40 includes unstructured text from aircraft maintenance logs or records. In certain embodiments, the unstructured text includes misspellings and/or multiple acronyms or synonyms for certain terms or phrases. In order to correct spelling errors in the raw data 40, the method 38 includes generating a spell correction model or module 44 (block 46) utilizing training data 48 (e.g., MRO training data that include misspellings) as described in greater detail below. In order to normalize synonymous terms (including acronyms) in the raw data 40, the method 38 includes generating a synonym (and acronym) identification model or module 50 (block 52) utilizing training data 54 (e.g., MRO training data that includes different synonyms and acronyms for particular terms or phrases) as described in greater detail below. In certain embodiments, the method 38 includes correcting spelling errors in the raw data 40 (block 56) resulting in spell corrected text 58. In certain embodiments, the method 38 includes normalizing synonymous terms (block 60) in the spell corrected text 58 resulting in synonym applied text 62. In other embodiments, the method 38 includes normalizing synonymous terms (block 60) in the raw data 40. In some embodiments, the method 38 does utilize correction of spelling errors (block 56) and/or normalization of synonymous terms (block 60).

In order to identify and analyze the MRO data using text mining algorithms, the method 38 includes generating a named entity recognition model 64 (block 66) utilizing training data 68 (e.g., manually labeled MRO data) as described in greater detail below. In certain embodiments, the named entity recognition model 64 includes a hidden Markov model (HMM). The method 38 includes utilizing the named entity recognition model 64 to perform named entity recognition on the synonym applied (and spell corrected) text 62 (block 70) to extract entities 72 from the unstructured MRO data. In certain embodiments, the named entity recognition may be performed (block 70) on spell corrected text 58 without normalization of synonymous terms or synonym applied text 62 without spell correction. As described in greater detail below, named entity recognition includes locating terms or phrases in the unstructured text, extracting the terms or phrases as entities 72, and labeling or tagging the entities 72. In certain embodiments, the tag or label indicates if the entity 72 is a part, an issue, or a correction-action (e.g., fix).

Following extractions of the entities 72, the method 38 includes performing an analysis on the extracted entities 72 (block 74) resulting in analyzed data or entities 76 as described in greater detail below. Examples of analyses may include determining an effectiveness of a fix for a specific issue, estimating a reliability of a component or a part, and/or clustering the analyzed entities or data 76 into symptom clusters that group specific parts and corresponding issues for the specific part under a common symptom. The method 38 also includes displaying the analysis data 76 of the extracted entities 72 (block 78) as described in greater detail below. For example, charts or graphs may be displayed (e.g., on display 36) that illustrate the fix effectiveness or reliability of components. Also, symptom cluster groups may be displayed.

As mentioned above, the techniques described herein may utilize the spell correction model or module 44 on the unstructured MRO text data. FIG. 3 is a process flow diagram illustrating a method 80 for building the spell correction model 44 and for correcting the spelling of the unstructured MRO text data. The unstructured MRO text data may include text describing a particular symptom (i.e., issue and corresponding part) and a corresponding corrective-action or fix for the particular symptom from aircraft maintenance logs or records. In certain embodiments, the corrective-action may not include a fix (e.g., it may recommend waiting a period of time before repairing) or describe whether the fix was effective. FIG. 3 depicts one or more databases 26 that include the unstructured MRO data. These include the raw text 40 (i.e., no spell correction or normalization of synonyms), spell corrected text 58, and synonym applied text 62 (which also may or may not be spell corrected).

As depicted in FIG. 3, algorithmic steps are indicated in the rectangles, model building steps are indicated in dashed rectangles, and model execution steps are indicated in solid rectangles. The spell correction model 44 is carried out by a machine learning algorithm (e.g., decision tree model) trained on a vocabulary of terms from aircraft (or other) maintenance logs.

To build the spell correction model 44, the method 80 includes extracting a set number of unique words or terms related to aircraft maintenance (e.g., 1000 words) from the raw text 40 of training or sample data (block 82). The training or sample data of raw text 40 is different from raw text data that the spell correction model 44 is applied to subsequent to building the model 44. From those extracted unique words or terms, the method 80 includes adding misspelled terms for the extracted unique words to pair with each extracted unique word (block 84). For example, the unique terms “system” and “regulator” may be respectively paired with the misspelled terms “systam” and “regulaor”. For each term-correction pair, the method 80 includes extracting features (block 86). These features may include statistical parameters such as a similarity score, term frequency, probability, a ranking of the term-correction pair, and other parameters. The features may also include determining if a term is English, if there is a difference (i.e., in spelling) between terms in a term-correction pair, and the length of a particular term. Other features may also be extracted. The method 80 further includes manually labeling (e.g., via a user) a correct transformation for each term-correction pair (block 88). For example, “systam” and “regulaor” may be respectively transformed or corrected to “system” and “regulator”. Alternatively, certain words that are spelled correctly may be transformed or corrected to a more popular term. For example, “control” may be corrected or transformed to “ctrl” because the later term may be a more popular term that biases the model 44 towards “ctrl”. Once the correct transformations are labeled, the method 80 includes building the model 44 (block 90). In certain embodiments, the model 44 includes a decision tree 92 based on the extracted features.

After building the model 44, the method 44 includes executing the model 44. Execution of the model 44 includes applying the decision tree 92 to raw MRO text 40 of interest (i.e., not the training data) (block 94) to the correct the spelling of the raw text 40 to spell corrected text 58. Applying the decision tree 92 on the raw text 40 includes executing inquiries based on the extracted features until a correct spelling is determined for the text of interest. Upon correcting the spelling, the spell corrected text 58 is provided to the database 26.

As mentioned above, the techniques described herein may utilize the synonym identification model or module 50 on the unstructured MRO text data. FIG. 4 is a process flow diagram illustrating a method 96 for building the synonym identification model 50 and for normalizing synonyms of the unstructured MRO text data. The unstructured MRO text data is as described above in FIG. 3. FIG. 4 depicts one or more databases 26 that include the unstructured MRO data. These include the raw text 40 (i.e., no spell correction or normalization of synonyms), spell corrected text 58, and synonym applied text 62 (which also may or may not be spell corrected). As depicted in FIG. 4, algorithmic steps are indicated in the rectangles, model building steps are indicated in dashed rectangles, and model execution steps are indicated in solid rectangles. Synonyms are derived in the synonym identification model 50 based on the distributional features of a word or term. Thus, based on the surrounding words for a given word synonyms are derived (e.g., context thesaurus).

To build the synonym identification model 50, the method 96 includes obtaining spell corrected text 58 of training or sample data related to aircraft maintenance and splitting the text 58 into trigram sequences (e.g., three word sequences) (block 98). In certain embodiments, the training or sample data may be raw text 40. The training or sample data of spell corrected text 58 or raw text 40 is different from the spell corrected text or raw text data that the synonym identification model 50 is applied to subsequent to building the model 50. The method 96 includes extracting context patterns for each trigram (block 100). Upon extracting the context patterns, the method 90 includes looking up other text within the sample spell corrected text 58 (or raw text 40) that includes the same context patterns (block 102). The method 96 further includes extracting terms from the text 40 or 58 that include the same context pattern and filtering this text 40 or 58 using heuristics rules (block 104) to generate a list of synonyms for each context pattern. In certain embodiments, the heuristic may include a “subsumes” heuristic for filtering a synonyms list. For example, in a “subsumes” heuristic the term “overspeed” may subsume the following terms: “ovspd”, “ovs”, “o/s”, and “over speed”. The method 96 includes adding the list of synonyms and associated context pattern to the synonym identification model 50 (block 106). In certain embodiments, the synonym identification model 50 includes a context thesaurus 108. In certain embodiments, the method 96 includes manually verifying (e.g., via a user) a sample of entries in the context thesaurus 108 (block 110).

After building the model 50, the method 96 includes executing the model 50. Execution of the model 50 includes applying the context thesaurus 108 to spell corrected MRO text 58 or, in certain embodiments, raw MRO text 40 of interest (i.e., not the training data) (block 112) to normalize the synonyms (e.g., synonym correct) the spell corrected text 58 or raw text to synonym corrected text 62. For example, the context thesaurus 108 may include the context “fixed * inop” and the synonym “landing light” for that context with the following as potential synonyms to be subsumed by the synonym “landing light”: “ll”, “l/t” “lndg lights”, “lnd light”, and “laight”. Upon normalizing synonymous terms, the synonym corrected or synonym applied text 62 is provided to the database 26. In certain embodiments, the synonym identification model 50 described above may also be used on acronyms during normalization of synonymous terms.

As mentioned above, the techniques described herein may utilize the named entity recognition model or module 64 on the unstructured MRO text data. FIG. 5 is a process flow diagram illustrating a method 114 for building the named entity recognition model 64 and for extracting entities 72 from the unstructured MRO text data. The unstructured MRO text data is as described above in FIG. 3. FIG. 4 depicts one or more databases 26 that include the unstructured MRO data. These include the raw text 40 (i.e., no spell correction or normalization of synonyms), spell corrected text 58, and synonym applied text 62 (which also may or may not be spell corrected). Even though as described below the building and applying of model 64 is used on spell corrected, synonym applied text 62, the model may be based on and applied to raw text 40, spell corrected text, or synonym applied text (not spell corrected). As depicted in FIG. 5, algorithmic steps are indicated in the rectangles, model building and testing steps are indicated in dashed rectangles, and model execution steps are indicated in solid rectangles. As described in greater detail below, the named entity recognition model 64 may include a HMM to extract and tag or label entities 72 from the unstructured MRO text data. For example, the extracted entities 72 may be tagged with a label or tag indicative of a part, issue, fix (or corrective-action), or some other qualifier.

To build the named entity recognition model 64, the method 114 includes obtaining spelling corrected, synonym applied text 62 of sample text data related to aircraft maintenance and splitting the text 62 (block 116) into training data and test data. As depicted, the sample data is split into approximately 70 percent training data and approximately 30 percent test data. In certain embodiments, the percentages of the training data and test data may vary. The sample data is different from the unstructured MRO data that the entity recognition model 64 is applied to subsequent to building the model 64. The method 114 includes manually tagging or labeling (e.g., via a user) sample text data as parts, issues, or fixes (or corrective-actions) (block 118). The method 114 also includes training on the labeled sample text to create the model 64 (block 120). The creation of the model 64 results in an output of model files 122 for the application of the model 64.

After building the model 64, the method 114 includes testing the model 64. Testing the model 64 includes applying the model 64 on the sample test data to extract and tag or label entities 72 from the unstructured sample text data (block 124). The method 114 includes verifying accuracy metrics (e.g., via a user) of the model 64 at extracting and tagging entities 72 (block 126).

After building and testing the model 64, the method 114 includes executing the model 64 by applying the model 64 (block 128) to unstructured MRO text data of interest. The named entity recognition model 64 extracts entities 72 from the unstructured MRO text data of interest and tags them with a label or tag indicative of a part 130, issue 132, fix 134 (or corrective-action), or some other qualifier 136. Upon extracting and tagging the entities 72, the entities 72 may be provided to the database 26 for subsequent analysis as described in greater detail below.

As mentioned above, the named entity recognition model 66 may include the HMM. The HMM is a Markov process (i.e., stochastic process) that includes unobserved or hidden states. In the HMM, the words of the unstructured MRO text data represent observations. The hidden states include the following: part (P), issue (I), other (O), and qualifier (Q). The O state also represents the fix (or corrective-action). The model building described above for the model 66 includes a bootstrap model building where the manually tagged sample text above is tagged with one of the state symbols (e.g., P, I, O, or Q). In the HMM, probability matrices Pi, A, and B are calculated. “Pi” represents the start probability, i.e., the probability that the state (P, I, O, or Q) occurred in the beginning of the unstructured MRO text data. The start probability is calculated for each of the states. “A” represents the transition probability, i.e., how many transitions occurred between the states (e.g., P to P, P to Q, P to I, P to O, Q to Q, Q to P, etc.). “B” represents the emission probability, i.e., the probability that a particular state (e.g., P) will emit a particular word (e.g., thrust). Thus, when the model 64 (i.e., HMM) is applied to the unstructured MRO text data of interest, the model 64 decodes or determines the most probable state sequence for each entity 72 (e.g., via a Viterbi algorithm), where the model 64 enumerates through all the state sequences and selects the one with the highest probability.

As described above, the extracted entities 72 may be analyzed in a variety of ways as illustrated in FIGS. 6-11. FIG. 6 is a process flow diagram of a method 138 for analyzing the extracted entities 72 to determine the fix effectiveness of a particular fix or corrective-action for a symptom (i.e., part and issue). The method 138 includes utilizing a heuristic 140 to estimate an effectiveness of a fix for a specific issue (block 142). The heuristic 140 is derived from historic MRO data. Thus, for example, in cases where an issue re-occurs on the same aircraft (e.g., same part and issue entities), a preceding fix may be marked as ineffective. After estimating an effectiveness of a fix or corrective action for a symptom, the method 138 includes generating an effectiveness chart (e.g., fix effectiveness chart) 144 (block 146). The method 138 also includes displaying the effectiveness chart 144 (e.g., on display 36) (block 148).

FIG. 7 provides an example of the fix effectiveness chart 144. FIG. 7 only provides one arrangement of the chart 144 and other arrangements may be utilized. As depicted, the chart 144 illustrates at the top a particular symptom 150 (e.g., “Bleed Air System Trip Off”). In addition, the symptom 150 is broken down into a part 152 (e.g., “Bleed Air System”) and issue 154 (e.g., “Trip Off”). In certain embodiments, the symptom 150, part 152, and issue 154 may not include labels. The chart 144 also includes a histogram 156 illustrating the fix effectiveness of corrective-actions on particular parts associated with the symptom 150. The histogram 156 includes y-axis 158 representing the effective/ineffective percentage of fixes or corrective actions for a particular part associated with the symptom 150 and x-axis 160 representing the parts associated with the symptom. As depicted, the histogram 156 represents the effective percentage for fixes on a particular part with a solid bar (e.g., solid bar portion 162 for “precooler control valve”) and represents the ineffective percentage for fixes on the particular part with a cross-hatched bar (e.g., cross-hatched portion 164 for “precooler control valve”). Overall, the chart 144 enables a user to visualize which parts are associated with the particular symptom 150, how often relative to the other parts a particular part is associated with the particular symptom 150, and the effective or ineffective percentage for fixes on the particular part. As depicted in the histogram 156, the parts are arranged from the most common to least common part associated with the symptom 150; however, this arrangement may be reversed (e.g., from least to most common) or the parts may be arranged in some other order (e.g., alphabetically by part name).

FIG. 8 is a process flow diagram of a method 166 for analyzing the extracted entities 72 to determine the reliabilities of components. The method 168 includes utilizing a heuristic 168 to estimate a reliability of a component or part (block 170). The heuristic 168 is derived from historic MRO data. Thus, for example, in cases where the same component or part on the same aircraft or over in a number of aircraft is repeatedly needing repair, the component may be marked as unreliable. After estimating a reliability of a component or part, the method 166 includes generating a component reliability chart 172 (block 174). The method 166 also includes displaying the effectiveness chart 172 (e.g., on display 36) (block 176).

FIG. 9 provides an example of the component reliability chart 172. FIG. 9 only provides one arrangement of the chart 172 as well as component reliability information and other arrangements (as well as other component reliability information) may be utilized. As depicted, the chart 172 illustrates at the top a particular aircraft system 174 (e.g., “Bleed Air System”). The chart 172 also includes a histogram 177 illustrating the component reliability of particular parts for the system 174. The histogram 177 includes y-axis 178 representing a frequency of events or incidents (e.g., maintenance, repair, overhaul, replacement, etc.) involving a part associated with the system 174 and x-axis 180 representing the parts associated with the symptom 174. As depicted, each bar (e.g., bar 182) of the histogram 177 represents the frequency of events or incidents for each part. Overall, the chart 174 enables a user to visualize which parts of the particular system 174 are most frequently involved in incidents or events (i.e., less reliable) relative to other parts of the system 174. As depicted in the histogram 177, the parts are arranged from the part with the higher frequency of events or incidents to the part with fewer events or incidents; however, this arrangement may be reversed (e.g., from a lower event frequency to higher event frequency) or the parts may be arranged in some other order (e.g., alphabetically by part name).

FIG. 10 is a process flow diagram of a method 184 for analyzing the extracted entities 72 to cluster the entities 72 into clusters (e.g., symptom clusters) 186. Each of the symptom clusters 186 group specific parts and corresponding issues for the specific parts under a common symptom (i.e., part and issue). The method 184 includes utilizing a clustering algorithm 188 to perform cluster analysis to cluster the entities 72 into symptom clusters 186 (block 190). After clustering the entities 72 into symptom clusters 186, the method 184 includes displaying the symptom clusters 186 (e.g., on display 36) (block 192).

FIG. 11 provides an example of a graphical representation of the symptom clusters 186. FIG. 11 only provides one arrangement of the clusters 186 and other arrangements may be utilized. As depicted, adjacent Venn diagrams, each representing symptom clusters 186, are disposed within a grouping (i.e., circle 194) representative of all of the symptoms in aircraft maintenance identified and analyzed in the techniques described above. As mentioned above, each symptom cluster 186 represents groupings of specific parts and corresponding issues for the specific parts under a common symptom (i.e., part/system and issue). For example, each symptom cluster 186 may include multiple sub-clusters 196 with specific parts (P) and corresponding issues (I) that may fall under the common symptom. In certain embodiments, the sub-cluster 196 may include a single issue and multiple parts associated with that issue (e.g., sub-cluster 198) or the sub-cluster 196 may include multiple issues associated with a single part (e.g., sub-cluster 200). Overall, the symptom clusters 186 provide an overall representation of the symptoms and the relationship between the issues and parts associated with those symptoms.

As described above, the extracted entities 72 may be analyzed to look at fix effectiveness. FIG. 12 is a process flow diagram of an embodiment of a method 202 for using a user interface to view fix effectiveness. FIGS. 13-17 illustrate representations of user interfaces to view fix effectiveness. As depicted in FIG. 12, the method 202 includes receiving user input selecting either parts or issues to view as a category on a user interface (block 204). As illustrated in respective user interfaces 206, 208 of FIGS. 13 and 14, the user interfaces 206, 208 provide an area 210 to select “parts” and an area 212 to select “issues”. In method 202, if the area 210 for parts is selected, the user interface 206 displays a graphical representation 214 (e.g., histogram) of particular parts and the frequency of fixes or corrective-actions associated with the parts (block 216) as depicted in FIG. 13. Alternatively, in method 202, if the area 212 for issues is selected, the user interface 208 displays a graphical representation 218 (e.g., histogram) of particular issues and the frequency of fixes or corrective-actions associated with the issues (block 220) as depicted in FIG. 14. In certain embodiments, the method 202 also includes displaying groupings 194 of symptom clusters 186 (block 222) as described above and as depicted in FIGS. 13 and 14.

Assuming parts were selected from the user interface 206, the method 202 also includes receiving a user input selecting a specific part (block 224). For example, as depicted in FIG. 15, the user may select a bar for a particular part (e.g., bar 226 representative of bleed duct). In certain embodiments, the bar (e.g., bar 226) may be highlighted. Upon selecting the specific part, the method 202 includes displaying graphical representations (e.g., histograms) of co-operating parts and issues associated with the specific part selected (block 228). For example, the user interface 206 displays a histogram 230 of co-operating parts of the specific part selected and the frequency of fixes or corrective-actions associated with that co-operating part as depicted in FIG. 15. Also depicted in FIG. 15, the user interface 206 displays a histogram 232 of issues associated with the specific part selected and the frequency of fixes or corrective-actions associated with a particular issue and the specific part selected. The method 202 further includes receiving a user input selecting a specific issue (block 234). For example, as depicted in FIG. 15, the user may select a bar for a particular issue (e.g., bar 236 representative of “trip off”). In certain embodiments, the bar (e.g., bar 236) may be highlighted. Upon selecting the specific issue (and thus a specific part-issue pairing, i.e., symptom), the method 202 includes displaying fix effectiveness information for the part-issue combination (i.e., symptom) (block 238). As depicted, displaying the fix effectiveness information after selecting the part-issue combination may involve clicking a button 240 (e.g., “next page” button). Alternatively, the fix effectiveness information may automatically be displayed.

Assuming issues were selected from the user interface 208, the method 202 also includes receiving a user input selecting a specific issue (block 242). For example, as depicted in FIG. 16, the user may select a bar for a particular part (e.g., bar 244 representative of “illuminated”). In certain embodiments, the bar (e.g., bar 244) may be highlighted. Upon selecting the specific issue, the method 202 includes displaying graphical representations (e.g., histograms) of related issues and parts associated with the specific issue selected (block 246). For example, the user interface 208 displays a histogram 248 of related issues of the specific issue selected and the frequency of fixes or corrective-actions associated with that related issue as depicted in FIG. 16. Also depicted in FIG. 16, the user interface 208 displays a histogram 250 of parts associated with the specific issue selected and the frequency of fixes or corrective-actions associated with a particular part and the specific issue selected. The method 202 further includes receiving a user input selecting a specific part (block 252). For example, as depicted in FIG. 16, the user may select a bar for a particular issue (e.g., bar 254 representative of “light”). In certain embodiments, the bar (e.g., bar 254) may be highlighted. Upon selecting the specific part (and thus a specific part-issue pairing, i.e., symptom), the method 202 includes displaying fix effectiveness information for the part-issue combination (i.e., symptom) (block 238). As depicted, displaying the fix effectiveness information after selecting the part-issue combination may involve clicking a button 240 (e.g., “next page” button). Alternatively, the fix effectiveness information may automatically be displayed.

FIG. 17 depicts a user interface 254 that appears after selecting a part-issue combination (i.e., symptom) in method 202 above that shows the fix effectiveness information. The user interface 255 displays a fix effectiveness chart 256 (e.g., histogram) similar to the chart described in FIG. 7 that includes various parts associated with the selected symptom and the percentage of effectiveness and ineffectiveness of fixes or corrective-actions associated with those parts. The user interface 255 may include graphical representations 258 of particular entries 260 associated with particular part-issue combinations falling under the selected symptom. The graphical representations 258 may group common part-issue combinations (e.g., for a particular aircraft) together (e.g., entries 262, 264). The graphical representations 258 include follow-up entries 260 (e.g., entry 266) linked to a particular entry 260 (e.g., entry 268). In certain embodiments, a specific entry 260 may be selected to obtain more specific information about the selected entry 260.

Technical effects of the disclosed embodiments include providing systems and methods for identifying and analyzing entities 72 from unstructured MRO text data obtained from aircraft maintenance logs or records. The systems and methods may include building models and applying the models to the unstructured MRO text data to provide an analysis of the MRO data. Analysis of the data may provide information about fix effectiveness, reliability of components, and other information. The information provided from the analysis may assist (e.g., maintenance engineers) in making more informed decisions about repair actions.

This written description uses examples to disclose the subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for identifying and analyzing data entities from (maintenance, repair, and overhaul (MRO)) data comprising:
obtaining MRO data comprising unstructured text information;
performing named entity recognition on the MRO data to extract entities from the unstructured text information and label the entities with a tag; and
analyzing the labeled entities via a heuristic to estimate an effectiveness of a fix for a specific issue or to estimate a reliability of a component.

2. The method of claim 1, wherein the tag indicates if the entity is a part, an issue, or a corrective-action.

3. The method of claim 1, comprising correcting spelling errors within the MRO data using a spell correction model prior to performing the named entity recognition.

4. The method of claim 3, comprising generating the spell correction model by training a machine learning algorithm using MRO data different from the obtained MRO data.

5. The method of claim 4, wherein the spell correction model comprises a decision tree.

6. The method of claim 1, comprising normalizing synonymous terms within the MRO data using a synonym identification model prior to performing the named entity recognition.

7. The method of claim 6, comprising generating the synonym identification model by constructing a context-based thesaurus.

8. The method of claim 1, wherein performing named entity recognition is performed using a hidden Markov model.

9. The method of claim 8, comprising generating the hidden Markov model prior to performing the named entity recognition by training the hidden Markov model on manually labeled MRO data different from the obtained MRO data, wherein labels of the manually labeled MRO data indicate parts, issues, or corrective-actions.

10. The method of claim 1, comprising generating and displaying a fix effectiveness chart based on the analyzed entities wherein the fix effectiveness chart illustrates a symptom that includes a specific part and corresponding issue, co-operating parts that have received fixes or corrective-actions, and an indicator of the effectiveness of the fixes or corrective actions on the co-operating parts.

11. The method of claim 1, comprising generating and displaying a component reliability chart based on the analyzed entities.

12. The method of claim 1, comprising clustering the analyzed entities into symptom clusters using a clustering algorithm and displaying the symptom clusters in relation to each other, wherein each symptom cluster groups specific parts and corresponding issues for the specific parts under a common symptom.

13. A system for identifying and analyzing data entities from (maintenance, repair, and overhaul (MRO)) data comprising:
a memory structure encoding one or more processor-executable routines, wherein the routines, when executed, cause acts to be performed comprising:
performing named entity recognition on MRO data to extract entities and to label the entities with a tag, wherein the MRO data comprises unstructured text information, and the tag indicates if the entity is a part, an issue, or a corrective-action; and
analyzing the labeled entities via a heuristic to estimate an effectiveness of a fix for a specific issue or to estimate a reliability of a component; and
a processing component configured to access and execute the one or more routines encoded by the memory structure.

14. The system of claim 13, wherein performing named entity recognition is performed using a hidden Markov model.

15. The system of claim 14, wherein the routines, when executed by the processing component, cause further acts to be performed comprising:
generating the hidden Markov model prior to performing the named entity recognition by training the hidden Markov model on manually labeled MRO training data, wherein labels of the manually labeled MRO training data indicate parts, issues, or corrective-actions.

16. The system of claim 13, wherein the routines, when executed by the processing component, cause further acts to be performed comprising:
generating a fix effectiveness chart for display based on the analyzed entities, wherein the fix effectiveness chart illustrates a symptom that includes a specific part and corresponding issue, co-operating parts that have received fixes or corrective-actions, and an indicator of the effectiveness of the fixes or corrective actions on the co-operating parts.

17. The system of claim 13, wherein the routines, when executed by the processing component, cause further acts to be performed comprising:
generating a component reliability chart for display based on the analyzed entities.

18. The system of claim 13, wherein the routines, when executed by the processing component, cause further acts to be performed comprising:
clustering the analyzed entities into symptom clusters using a clustering algorithm and displaying the symptom clusters in relation to each other, wherein each symptom cluster groups specific parts and corresponding issues for the specific parts under a common symptom.

19. The system of claim 13, wherein the routines, when executed by the processing component, cause further acts to be performed comprising:
correcting spelling errors within the MRO data using a spell correction model prior to performing the named entity recognition; and
normalizing synonymous terms within the spell corrected MRO data using a synonym identification model prior to performing the named entity recognition.

20. One or more non-transitory computer-readable media encoding one or more processor-executable routines, wherein the one or more routines, when executed by a processor, cause acts to be performed comprising:
performing named entity recognition on (maintenance, repair, and overhaul (MRO)) data to extract entities and to label the entities with a tag, wherein the MRO data comprises unstructured text information, and the tag indicates if the entity is a part, an issue, or a corrective-action; and
analyzing the labeled entities via a heuristic to estimate an effectiveness of a fix for a specific issue or to estimate a reliability of a component.

21. The one or more non-transitory computer-readable media of claim 20, wherein performing named entity recognition is performed using a hidden Markov model.

22. The one or more non-transitory computer-readable media of claim 21, wherein the one or more-routines, when executed by the processor, cause further acts to be performed comprising:
generating the hidden Markov model prior to performing the named entity recognition by training the hidden Markov model on manually labeled MRO data different from the obtained MRO data, wherein labels of the manually labeled MRO data indicate parts, issues, or corrective-actions.

23. The one or more non-transitory computer-readable media of claim 20, wherein the one or more-routines, when executed by the processor, cause further acts to be performed comprising:
generating a fix effectiveness chart for display based on the analyzed entities wherein the fix effectiveness chart illustrates a symptom that includes a specific part and corresponding issue, co-operating parts that have received fixes or corrective-actions, and an indicator of the effectiveness of the fixes or corrective actions on the co-operating parts.

24. The one or more non-transitory computer-readable media of claim 20, wherein the one or more-routines, when executed by the processor, cause further acts to be performed comprising:
generating a component reliability chart for display based on the analyzed entities.

25. The one or more non-transitory computer-readable media of claim 20, wherein the one or more-routines, when executed by the processor, cause further acts to be performed comprising:
clustering the analyzed entities into symptom clusters using a clustering algorithm and displaying the symptom clusters in relation to each other, wherein each symptom cluster groups specific parts and corresponding issues for the specific parts under a common symptom.
